(19) United States
(12) Patent Application Publication
(10) Pub. No.: US 2014/0266985 A1
(43) Pub. Date: Sep. 18, 2014

(54) SYSTEM AND METHOD FOR CHROMATIC ABERRATION CORRECTION FOR AN IMAGE PROJECTION SYSTEM

(71) Applicant: LOCKHEED MARTIN CORPORATION, Bethesda, MD (US)

(72) Inventors: GREGORY A. HARRISON, Oviedo, FL (US); David Alan Smith, Cary, NC (US); Scott Pottenger, Truckee, CA (US)

(73) Assignee: LOCKHEED MARTIN CORPORATION, Bethesda, MD (US)

(21) Appl. No.: 13/834,515

(22) Filed: Mar. 15, 2013

(51) Int. Cl. G09G 3/36

(52) U.S. Cl. CPC G09G 3/3607
USPC 345/8; 345/88

(57) ABSTRACT

A system and method for reduction of chromatic aberration for an image projection system utilizes a computer system that processes a parametric equation that defines the physical parameters of a projection lens unit. Based on the parametric equation, the divergence or refractive induced bending of light rays passing through the lens unit is identified. This divergence data is then utilized to generate offset values that are transferred to a control unit of a digital image display unit so as to offset, or otherwise space apart, the position of specific color sub-pixels by an appropriate amount to compensate for the divergence or bending effects of the lens unit. The applied offset causes the color light rays emitted by the color pixels to converge or otherwise join after passing through the lens, thus eliminating, or otherwise minimizing the chromatic aberration associated with the projected image.

### TECHNICAL FIELD

Generally, the present invention relates to image projection systems that project images through a lens unit. In particular, an embodiment of the invention is directed to a system and method for reduction of chromatic aberrations of images that are projected through a lens unit for direct view by a viewer's eye or upon an imaging surface. Specifically, an embodiment of the invention is directed to a system and method for reducing chromatic aberrations by offsetting the relative position of color sub-pixels of an image display unit, such as an LCD (liquid crystal display), so that the color light rays emitted therefrom converge after passing through the projection lens unit and are rendered in a viewer's eye or upon an imaging screen.

### BACKGROUND ART

Recently, high-performance image projection systems, including digital projection display systems, such as digital video projection systems used in movie theaters, head-wearable displays (HWD) used by aircraft pilots or in virtual/augmented reality applications, and other head-up displays (HUD) have increased in use. These image projection display systems use an image display unit that is formed as an array or matrix of individually controllable pixels, such as a LC (liquid crystal) display, which produces a color image that is projected through one or more lenses of a lens unit. Depending on the particular application, the projected image passing through the lens unit may be viewed directly by a viewer's eye without any intervening optics or components therebetween, as in the case of near-to-the eye head wearable displays (HWD). For example, head wearable displays (HWD), such as those used by pilots, allow pilots to directly view various projected images and data, and in some cases, to allow them to simultaneously view their surrounding environment. Such HWD displays often provide a wide field of view (FOV), such as 180 degrees for example, to allow users to view information of a wide range of space, and in some cases allow users a full field of view of their external environment. Alternatively, the projected image passing through the lens unit may be incident upon any suitable imaging surface, such as a screen, as in the case of a movie theatre.

However, because such image projection systems produce images that are projected through a lens unit, they are subject to chromatic aberrations. As used herein, chromatic aberration generally refers to the variation of either the focal length, magnification or other characteristic of a lens system with differing wavelengths of light, mostly characterized by prismatic coloring at the edges of the optical image and color distortion within it. In other words, chromatic aberration may result from a defect in the lens system in which different wavelengths of light are focused at different distances because they are refracted or otherwise directed through the lens system at different angles. This refraction or other variance may produce a blurred image with colored fringes. As such, the lens system may be unable to bring various colors or wavelengths of light to focus on a single point. These chromatic aberrations may be the result of the divergence (i.e. change in direction or variation in refraction angle) of the RGB light rays emitted from the red, green, and blue or RGB sub-pixels that form the display image as they pass through the lens unit of the projection system. As a result, the light rays emitted by the color RGB sub-pixels may not be properly focused at a common point on the viewing surface when viewed by a viewer. That is, due to the curvature of the lens unit, and the varying speeds in which different colored light rays pass through the particular material from which the lens unit is formed, each RGB color light ray emitted by the sub-pixels of the display unit may be refracted by the lens unit of the image display unit at a different angle, thus causing a divergence of the color light rays as they pass therefrom. This divergence of the light rays out of the lens unit may result in chromatic aberrations, such as color fringing, which appears along the boundaries between the light and dark portions of the resultant image, where the RGB light rays have not correctly converged or focused. Furthermore, the color fringing effects are often more pronounced around the perimeter of the projected image, than in the middle of the projected image, and they also tend to become more drastic as a projected image is made larger. As such, designers of image projection systems, such as HUDs and digital projection systems, are often required to limit the size of the display, so that it has a relatively narrow field of view (FOV) to reduce the unwanted effects of color fringing.

In the past, elaborate and complex lens arrangements were utilized to minimize the appearance of chromatic aberrations in the projected image. However, such complex lens arrangements are costly and time consuming to design and add unwanted bulk and weight to the image projection system.

Therefore, there is a need for a system and method for correcting or reducing chromatic aberrations for an image projection system using parametric equations to define the physical parameters of a projection lens unit to identify the relative divergence of color light rays passing therethrough. Furthermore, there is a need for a system and method for correcting or reducing chromatic aberrations for image projection systems in which the divergence of color light rays passing through the projection lens unit is compensated by off-setting, or otherwise adjusting, the position of the sub-pixels of the image display unit relative to one another, so that the color light rays emitted therefrom converge after passing through the projection lens unit. In addition, there is a need for a system and method for correcting chromatic aberrations for an image projection system, so that images can be projected for direct view by a viewer's eyes or upon an imaging surface without the effects of color fringing.

### SUMMARY OF THE INVENTION

In light of the foregoing, it is a first aspect of the present invention to provide a system and method for chromatic aberration for an image projection system.

It is another aspect of the present invention to provide system for reduction of chromatic aberration of a projected image comprising an image display unit having a plurality of pixels, each pixel having at least a first, a second, and a third sub-pixel that generates respective first, second, and third light rays that are each a different color, a lens unit through which the first, second, and third light rays pass, and a control system coupled to the image display unit, the control system adapted to store offset data generated from a virtual lens model defining the refractive differences of the first, second, and third light rays when passing through the virtual lens model, wherein the control system compensates for the divergence of the first, second, and third light rays by offsetting the position of the sub-pixels relative to each other based on the offset data for each pixel, such that the first, second, and third light rays join when passing through the lens unit.

Yet another aspect of the present invention is to provide a system for reduction of chromatic aberration of a projected image comprising an image display unit having a plurality of pixels, each pixel having a first, a second, and a third sub-pixel that generates respective first, second, and third light rays that are each a different color, a lens unit through which the first, second, and third light rays pass, and a control system having a memory unit adapted to store offset values associated with the divergence of the first, second, and third light rays through the lens unit, wherein for each pixel, the control system retrieves the offset values from the memory unit and offsets the position of the sub-pixels relative to each other, such that the first, second, and third light rays combine when passing through the lens unit.

Still another aspect of the present invention is to provide a method of reducing chromatic aberrations in a projected image comprising providing an image display unit having a plurality of pixels, each pixel having a first, second, and third sub-pixel from which respective first, second, and third light rays are emitted through a lens unit, providing a computer system adapted to receive a virtual model of the lens unit, calculating the divergence of the first, second, and third light rays through the lens unit based on the virtual model of the projection lens unit at the computer system, generating one or more offset values the light rays based on the calculating step, and controlling the image display unit in accordance with the one or more offset values to adjust the relative position of the first, second, and third sub-pixels to one another for each pixel, whereupon the first, second, and third light rays join when passing through the lens unit.

### BRIEF DESCRIPTION OF THE DRAWINGS

These and other features and advantages of the invention will become better understood with regard to the following description, appended claims, and accompanying drawings wherein:

FIG. 1A is a schematic diagram of an image projection system when chromatic aberration correction is not applied to a projected image for viewing directly by a viewer's eyes in accordance with the concepts of the present invention;

FIG. 1B is a schematic diagram of the image projection system when chromatic aberration correction is not applied to a projected image for viewing by a viewer's eyes indirectly upon an imaging screen in accordance with the concepts of the present invention;

FIG. 2A is a schematic diagram of the image projection system that provides chromatic aberration correction for a projected image for viewing directly by a viewer's eyes in accordance with the concepts of the present invention;

FIG. 2B is a schematic diagram of the image projection system that provides chromatic aberration correction for a projected image for viewing by a viewer's eyes indirectly upon an imaging screen in accordance with the concepts of the present invention; and

FIG. 3 is a flow diagram of the operational steps taken by the imaging projection system to provide chromatic aberration correction in accordance with the concepts of the present invention.

### DETAILED DESCRIPTION OF THE INVENTION

A system for reducing chromatic aberration for an image projection system is generally referred to by numeral 10, as shown in FIGS. 1-2 of the drawings. Specifically, the system 10 includes a control system 20, which may comprise any suitable general purpose or application specific computing device that has the necessary memory, hardware and software to carry out the functions to be discussed. Coupled to the control system 20 is an image display unit 30, such as an LC (liquid crystal) display, or any other digital display device formed of an array of independently controllable and addressable color pixels 24. While the image display unit may utilize any number of pixels and sub-pixels of any number and color, the following discussion is based on an image display unit 30 having pixels 24 that each include three color sub-pixels 32, such as red (R) 40, green (G) 50, and blue (B) 60 sub-pixels. The RGB sub-pixels 40, 50, 60 generate respective light rays 100, 110, 120, which are received by a projection lens unit 150, which may comprise one or more optical lenses. In one aspect, it should be appreciated that the components of the system 10, including control system 20 and lens unit 150 may be integrated as a wearable device, such as a head wearable display (HWD), or any other wearable device.

Before discussing the operational aspects of the system 10, it is submitted, that the reader will appreciate that the light rays 100, 110, 120 in FIGS. 1-2 are shown as separate rays for purposes of facilitating the discussion of the present invention, and that they are effectively emitted from the image display unit 30 as a combined beam that is incident upon the lens unit 150.

Continuing, the lens unit 150 may comprise a collimating lens that is configured to directly focus the image delivered from the image display unit 30 in the viewer's eyes 160, as shown in FIGS. 1A and 2A. In addition, the lens unit 150 may focus the image delivered from the image display unit 30 upon the imaging surface 170, such as a screen, or any other suitable surface, including an opaque, transparent, or semitransparent surface for example, for indirect viewing by the eyes 160 of the viewer, as shown in FIGS. 1B and 2B.

Thus, due to the nature of light, the color light rays 100, 110, 120 emitted by the color sub-pixels 40, 50, 60 are refracted at different angles as they pass through the lens unit 150 causing them to diverge away from each other, as shown in FIGS. 1A-B. It should be appreciated that the term “diverge” or “divergence” as used herein, defines a change in direction or variation in refraction angle of the light rays 100, 110, 120 as they pass through the lens unit 150. Furthermore, the light ray divergence (i.e. change in direction/variation in refraction angle) is based on the principle that light rays of different colors move through the lens unit 150 at different angles due to the various physical characteristics of the lens unit 150, including the material from which it is formed and its curvature, as well as the varying speeds in which the different color light rays 100, 110, 120 travel through the material of the lens unit 150. Thus, each of the RGB light rays 100, 110, 120 passing through the lens unit 150 are each focused at a different point on the viewer's eye 160, as shown in FIG. 1A or at different points on the imaging surface 170, as shown in FIG. 1B, which results in the appearance of chromatic aberrations or color fringing in the projected image. Thus, the system 10 is configured to eliminate or otherwise reduce the appearance of chromatic aberrations by compensating for the divergence of the light rays 100, 110, 120 after they pass through the lens unit 150 by controlling the relative position of the RGB sub-pixels 40, 50, 60 of the image display unit 30 based on a virtual model of the lens unit 150, as discussed in detail below.

Thus, the operational steps taken by the system 10 to correct the appearance of chromatic aberrations in a projected image are generally referred to by the numeral 200, as shown in FIG. 3. Initially, at step 210 of the process a parametric model of the lens unit 150 is processed by a computer system 202, as shown in FIGS. 1-2, remotely from the control system 20, however it should be appreciated that the control system 20 may be configured to perform such operation as well. It should be appreciated that the computer system 202 may comprise any computing device suitable for processing the parametric model of the lens unit 150. The parametric model is a virtual model of the lens unit 150 that defines the physical properties of the lens unit 150, including, but not limited to, its shape and material from which it is formed, and any other physical features. Using the parametric model of the lens unit 150, the computer system 202 identifies the divergence of the red, green, and blue light rays 100, 110, 120 that occurs when they pass through the modeled lens unit 150. As previously discussed, the divergence of the different colored light rays 100, 110, 120 that are emitted by the image display unit 30 is based on the curvature of the lens unit 150, the material from which the lens unit 150 is made, and the color or wavelength of the light ray 40, 50, 60 that determines its speed when passing through the lens unit 150. These parameters are considered by the virtual model of the lens unit 150, allowing the computer system 202 to identify the divergence of the RGB light rays 100, 110, 120 passing through the lens unit 150, as indicated at step 220. It should be appreciated that there are numerous approaches to identify the divergence of the light rays 100, 110, 120. For example, one approach is to trace back or follow the light rays 100, 110, 120 from the viewer's eye 160 back through the lens unit 150, taking into account its divergent effects, and identifying the points at which the RGB light rays 100, 110, 120 are incident upon the image display unit 30. These points where the back traced light rays 100, 110, 120 are incident upon the image display unit 30 identify the necessary relative positioning of the color sub-pixels 40, 50, 60 that is needed, so that the light rays 100, 110, 120 emitted through the lens unit 150 during normal operation of the system 10 converge or otherwise join and form a combined focus on a common point of the viewer's eye 160.

Once the divergence of the RGB light rays 100, 110, 120 has been identified, the process continues to step 230, where the computer system 202 calculates the offset values or other factors based on the divergence of the RGB light rays 100, 110, 120 when passing out of the lens unit 150. Specifically, the calculated offset values may be based on the refractive differences of the light rays 100, 110, 120 when passing through the modeled virtual lens unit 150. As such, the offset values may define the necessary separation distance that is needed between the sub-pixels 40, 50, 60 of each pixel 24 of the image display unit 30 to enable the RGB light rays 100, 110, 120 emitted therefrom to compensate for these differences, so as to enable the converge or joining of the light rays 100, 110, 120 when they pass out of the lens unit 150, as indicated at step 230. The computer system 202 includes a memory unit that stores the offset values for each pixel in relation to the lens unit. Skilled artisans will appreciate that the offset values are unique for each pixel in view of each pixel's unique position in relation to the viewer's eyes 160 or imaging surface 170. It will further be appreciated that each pixel's offset value may be adjusted according to the desired intensity of the image being displayed. In any event, the control system 20 retrieves the offset values from the memory unit as needed.

Next, after the offset values are identified for each pixel 24 of the image display unit 30 they are transferred by the computer system 202 to a memory unit provided by the control system 20, at step 232. The transfer of the offset values may take place using any suitable wired or wireless communication interface. It should also be appreciated that the computer system 202 may be integral with the control system 20 if desired. Once the offset values are transferred, the process continues to step 240, where the control system 20 controls the image display unit 30 to adjust the relative position of each of the RGB sub-pixels 40, 50, 60, in accordance with the calculated offset values. This may be achieved by controlling the image display unit 30, such that one or more of the sub-pixels 40, 50, 60 of a given base pixel 24 are combined with one or more sub-pixels 40, 50, 60 of an adjacent or surrounding pixel 24′, as shown in FIGS. 2A-B. This has the effect of forming a new effective pixel 24″ in which the relative spacing or distance between each of the RGB sub-pixels 40, 50, 60 may be adjusted (increased/decreased). Such process may be replicated as necessary for the plurality of pixels 24 that are provided by the image display unit 30, thus resulting in an array of new effective pixels 24″. As a result of this repositioning of sub-pixels 40, 50, 60 in each effective pixel 24″ based on the calculated offset values, the alignment of the emitted light rays 100, 110, 120 may be effectively altered upon receipt by the lens unit 150. The light rays 100, 110, 120 may then converge or otherwise join to form a resultant ray 242 after passing through the lens unit 150 that is focused at a single point on the viewer's eyes 160, as shown in FIG. 2A, or upon the imaging surface 170, as shown in FIG. 2B.

For example, step 240 may be carried out to form the new effective pixel 24″ from the combination of pixels 24 and 24′ by controlling the image display unit 30 to turn the blue (B) 60 sub-pixel of pixel 24′ and the red (R) 40 and green (G) 50 sub-pixels of pixel 24 off, or otherwise disabling them, as identified by the designation “X” in FIG. 1B. As a result, the new effective pixel 24″ forms a pixel with redefined sub-pixel spacing, whereby a gap or space is now formed by the disabled pixels “X” between the green (G) sub-pixel 50 of pixel 24′ and the blue (B) sub-pixel 60 of pixel 24. It should be appreciated that while the effective pixel 24″ discussed herein is formed from sub-pixels of two base pixels 24, a total of 3 base pixels 24, each contributing one of the 3 RGB colors, may be used to create a single effective pixel 24″. Accordingly, in embodiments where pixel color schemes other than RGB, which use more or less than 3 colors, it is similarly contemplated that an effective pixel may be comprised of sub-pixels from a number of base pixels that is equal to the total number of color sub-pixels in the base pixel.

Finally, at step 250, the RGB light rays 100, 110, 120 emitted from the reoriented effective pixels 24″ may converge or otherwise join after passing through the lens unit 150 to the viewer's eye 160 or imaging surface 170, thus removing, or otherwise reducing the appearance of chromatic aberrations in the resultant image, as shown in FIGS. 2A-B.

As a result of the foregoing process implemented by the system 10, the computing system 20 may compensate for the offset of each pixel's sub-pixels by utilizing at least one sub-pixel of pixels surrounding the pixel. In other words, the control system 20 may selectively switch sub-pixels of each pixel off and on, and may selectively switch sub-pixels of surrounding or adjacent pixels off and on to form a new effective pixel 24″ that enable a rendered image to be viewed directly by the viewer's eyes 160 or indirectly upon an imaging screen 170 with reduced or no chromatic aberration.

Therefore, one advantage of an embodiment of the invention is that a system and method for reduction of chromatic aberration of a projected image may identify and compensate for the divergence of color light rays, such as red (R), green (G), and blue (B) light rays, passing through a lens unit for direct view by a viewer or indirect view via an imaging screen. Still another advantage of an embodiment of the invention is that a system and method for reduction of chromatic aberration is enabled to control the relative position of each color sub-pixel of a plurality of pixels of an image display unit to offset or space apart the light rays generated therefrom using offset values based on the divergence, or variation in refraction angles of the difference color light rays through a lens unit. Yet another advantage of an embodiment of the invention is that a system for chromatic aberration correction of a projected image is that it can be easily retrofit and implemented in existing image projection systems by modeling a lens unit and adjusting the operation of the pixels according to that model.

Thus, it can be seen that the objects of the invention have been satisfied by the structure and its method for use presented above. It is to be understood that the invention is not limited to the embodiments presented and described in detail herein. Accordingly, for an appreciation of the true scope and breadth of the invention, reference should be made to the following claims.

What is claimed is:

1. A system for reduction of chromatic aberration of a projected image comprising:
an image display unit having a plurality of pixels, each said pixel having at least a first, a second, and a third sub-pixel that generates respective first, second, and third light rays that are each a different color;
a lens unit through which said first, second, and third light rays pass; and
a control system coupled to said image display unit, said control system adapted to store offset data generated from a virtual lens model defining the refractive differences of said first, second, and third light rays when passing through said virtual lens model;
wherein said control system compensates for the divergence of said first, second, and third light rays by offsetting the position of said sub-pixels relative to each other based on said offset data for each said pixel, such that said first, second, and third light rays join when passing through said lens unit.

2. The system of claim 1, wherein said image display unit and said lens unit is carried by a wearable device.

3. The system of claim 1, further comprising a display surface upon which said first, second, and third light rays are incident.

4. The system of claim 1, wherein said first, second, and third light rays, comprise red, green, and blue light rays respectively.

5. The system of claim 1, wherein said image display unit comprises a liquid crystal display.

6. The system of claim 1, wherein said computing system compensates for the offset of each said pixel's sub-pixels by utilizing at least one sub-pixel of pixels surrounding each said pixel.

7. The system of claim 1, wherein said computing system selectively turns said surrounding sub-pixels of said other pixels on and off and each said pixel's sub-pixels on and off to form a new effective pixel without chromic aberration.

8. A system for reduction of chromatic aberration of a projected image comprising:
an image display unit having a plurality of pixels, each pixel having a first, a second, and a third sub-pixel that generates respective first, second, and third light rays that are each a different color;
a lens unit through which said first, second, and third light rays pass; and
a control system having a memory unit adapted to store offset values associated with the divergence of said first, second, and third light rays through said lens unit;
wherein for each said pixel, said control system retrieves said offset values from said memory unit and offsets the position of said sub-pixels relative to each other, such that said first, second, and third light rays combine when passing through said lens unit.

9. The system of claim 8, wherein said image display unit and said lens unit is carried by a wearable device.

10. The system of claim 8, further comprising a display surface upon which said first, second, and third light rays are incident.

11. The system of claim 8, wherein said first, second, and third light rays, comprise red, green, and blue light rays respectively.

12. The system of claim 8, wherein said image display unit comprises a liquid crystal display.

13. A method of reducing chromatic aberrations in a projected image comprising:
providing an image display unit having a plurality of pixels, each said pixel having a first, second, and third sub-pixel from which respective first, second, and third light rays are emitted through a lens unit;
providing a computer system adapted to receive a virtual model of said lens unit;
calculating the divergence of said first, second, and third light rays through said lens unit based on said virtual model of said projection lens unit at said computer system;
generating one or more offset values said light rays based on said calculating step; and
controlling said image display unit in accordance with said one or more offset values to adjust the relative position of said first, second, and third sub-pixels to one another for each said pixel;
whereupon said first, second, and third light rays join when passing through said lens unit.

14. The method of claim 13, wherein said first, second, and third light rays, comprise red, green, and blue light rays respectively.

15. The method of claim 13, further comprising
adjusting the relative position of each said sub-pixel by combining one or more sub-pixels of pixels surrounding each said sub-pixel.

16. The method of claim 13, further comprising
selectively turning said surrounding sub-pixels on and off and each said pixel's on and off to form a new effective pixel.
